(19) United States
(12) Patent Application Publication
(10) Pub. No.: US 2010/0008235 A1
(43) Pub. Date: Jan. 14, 2010

(54) REPORTING AND RESOLVING CONFLICTING USE OF A NODE IDENTIFIER

(75) Inventors: Peerapol Tinnakornsrisuphap, San Diego, CA (US); Gavin B. Horn, La Jolla, CA (US); Parag A. Agashe, San Diego, CA (US); Rajarshi Gupta, Santa Clara, CA (US); Rajat Prakash, La Jolla, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/499,701

(22) Filed: Jul. 8, 2009

Related U.S. Application Data
(60) Provisional application No. 61/080,068, filed on Jul. 11, 2008.

(51) Int. Cl. H04L 12/24; H04L 12/26

(52) U.S. Cl. 370/241; 370/254

(57) ABSTRACT

Conflicting use of a node identifier in a wireless network is reported and resolved. In some aspects, a wireless node receives wireless signals and determines, based on those signals, that more than one node uses the same node identifier. The wireless node may then report the conflicting use to a network node. Here, the wireless node may delay for a period of time before reporting the conflicting use. In some aspects, an access point that discovers a conflicting use (e.g., based on a received signal that indicates that another access point is using that same node identifier) may report the conflicting use and/or elect to use a different node identifier. In some aspects, a stateful procedure is used to resolve a conflicting use where, upon identification of a conflicting use, an access point negotiates with another access point to cause one of these access points to use a different node identifier. In some aspects, a stateless procedure is used to resolve a conflicting use where, upon identification of a conflicting use, an access point delays for a period of time before determining whether a different node identifier is to be used at one of the nodes.

### CLAIM OF PRIORITY

This application claims the benefit of and priority to commonly owned U.S. Provisional Patent Application No. 61/080,068, filed Jul. 11, 2008, and assigned Attorney Docket No. 081985P1, the disclosure of which is hereby incorporated by reference herein.

### BACKGROUND

1. Field

This application relates generally to wireless communication and more specifically, but not exclusively, to reporting and resolving conflicting use of a node identifier.

2. Introduction

Wireless communication systems are widely deployed to provide various types of communication (e.g., voice, data, multimedia services, etc.) to multiple users. As the demand for high-rate and multimedia data services rapidly grows, there lies a challenge to implement efficient and robust communication systems with enhanced performance.

To supplement conventional mobile phone network access points, small-coverage access points may be deployed (e.g., installed in a user's home) to provide more robust indoor wireless coverage to mobile units. Such small-coverage access points may be known as, for example, access point base stations, Home NodeBs, Home eNodeBs, pico cells, or femto cells. Typically, such small-coverage access points are connected to the Internet and the mobile operator's network via a DSL router or a cable modem.

In a conventional wireless network, each access point (e.g., each sector or cell) is assigned a long identifier which may be referred to as, for example, a global cell identifier (“GCI”), a sector identifier (“SectorID”), an access node identifier (“ANID”), or as some other type of identifier. Additionally, each access point may be assigned a short identifier, which may be referred to as, for example, a physical cell identifier (“PCI”), a pilot pseudorandom number (“PilotPN”), or as some other type of identifier. The short identifier may be used to modulate physical layer channels. Since this identifier is relatively short, an access terminal may be able to efficiently search for a waveform, such as a time division multiplexed (“TDM”) pilot, corresponding to that short identifier. This helps the access terminal identify the cells (e.g., sectors) in its vicinity and demodulate their transmissions, which also may be scrambled by the short identifier.

Typically, the space allocated for the short identifiers is relatively limited. Consequently, it is desirable for a network operator to ensure that the same short identifier is not used by access points that are relatively close to each other to avoid conflicting use of the identifier (e.g., identifier collision and/or identifier confusion). While this is feasible in a traditional planned network, it may not be feasible in an unplanned or ad-hoc network (e.g., a network employing many small-coverage access points). In an ad-hoc network, the network operator or a customer may deploy an access point without knowing which short identifier should be used to ensure that an identifier conflict never occurs (if an identifier conflict is indeed entirely avoidable). Thus, there is a need for effective techniques for managing identifier conflict in wireless networks.

### SUMMARY

A summary of sample aspects of the disclosure follows. It should be understood that any reference to the term aspects herein may refer to one or more aspects of the disclosure.

The disclosure relates in some aspects to identifying, reporting, and resolving conflicting use of a node identifier in a wireless network. Here, conflicting use may relate to identifier confusion or identifier collision.

In some aspects, conflicting use of a node identifier is identified based on received wireless signals. For example, a wireless node (e.g., an access terminal or an access point) may receive wireless signals and determine, based on those signals, that more than one node uses the same node identifier. The wireless node may then report the conflicting use to a network node (e.g., an access point or a network operations and management entity). In some aspects, the wireless node delays for a period of time before reporting the conflicting use to reduce the likelihood that multiple wireless nodes will concurrently report the same conflicting use.

The disclosure relates in some aspects to detecting a conflicting use at an access point. For example, an access point that uses a particular node identifier may receive a signal that indicates that another access point is using that same node identifier. The access point may then determine whether the uses of the node identifier are conflicting. If so, the access point may report the conflicting use and/or elect to use a different node identifier.

The disclosure relates in some aspects to resolving conflicting use of a node identifier through the use of stateful or stateless conflict resolution procedures. In some aspects a stateful procedure may be employed whereby, upon identification of a conflicting use, an access point communicates (e.g., negotiates) with another access point to cause one of these access points to use a different node identifier. In some aspects, a stateless procedure may be employed where, upon identification of a conflicting use, an access point delays for a period of time before determining whether a different node identifier is to be used at one of the conflicting access points.

### BRIEF DESCRIPTION OF THE DRAWINGS

These and other sample aspects of the disclosure will be described in the detailed description and the appended claims that follow, and in the accompanying drawings, wherein:

FIG. 1 is a simplified block diagram of several sample aspects of a communication system configured to report and resolve conflicting use of an identifier;

FIG. 2 is a flowchart of several sample aspects of operations that may be performed in conjunction with reporting conflicting use of an identifier;

FIG. 3 is a flowchart of several sample aspects of operations that may be performed by an access point in conjunction with identifying conflicting use of an identifier;

FIG. 4 is a flowchart of several sample aspects of operations that may be performed in conjunction with resolving conflicting use of an identifier;

FIG. 5 is a flowchart of several sample aspects of operations that may be performed in conjunction with multiple nodes communicating to resolve conflicting use of an identifier;

FIG. 6 is a flowchart of several sample aspects of operations that may be performed in conjunction with negotiating to resolve conflicting use of an identifier;

FIG. 7 is a flowchart of several sample aspects of operations that may be performed in conjunction with resolving conflicting use of an identifier;

FIG. 8 is a simplified diagram of a wireless communication system;

FIG. 9 is a simplified diagram of a wireless communication system including femto nodes;

FIG. 10 is a simplified diagram illustrating coverage areas for wireless communication;

FIG. 11 is a simplified block diagram of several sample aspects of communication components; and

FIGS. 12-15 are simplified block diagrams of several sample aspects of apparatuses configured to perform one or more of identifying, reporting, or resolving conflicting use of an identifier as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

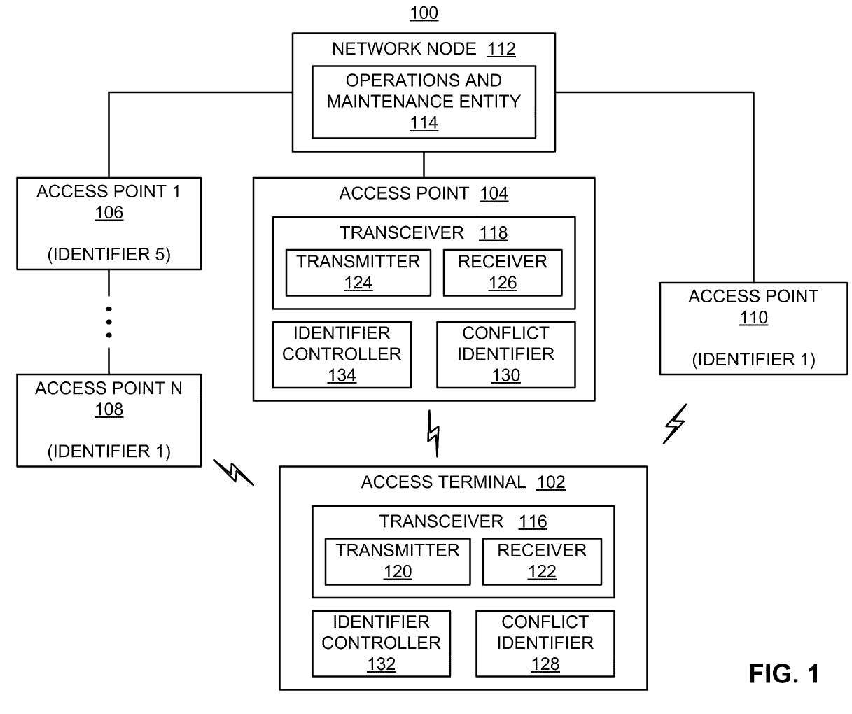

FIG. 1 illustrates several nodes of a sample communication system 100 (e.g., a portion of a communication network). For illustration purposes, various aspects of the disclosure will be described in the context of one or more access terminals, access points, and network nodes that communicate with one another. It should be appreciated, however, that the teachings herein may be applicable to other types of apparatuses or other similar apparatuses that are referenced using other terminology. For example, in various implementations access points may be referred to or implemented as base stations or eNodeBs, access terminals may be referred to or implemented as user equipment or mobile stations, and so on.

Access points in the system 100 provide one or more services (e.g., network connectivity) for one or more wireless terminals that may be installed within or that may roam throughout a coverage area of the access points. For example, at various points in time an access terminal 102 may connect to an access point 104, any one of a set of access points 1-N (represented by access points 106 and 108 and the associated ellipsis), or an access point 1 10. Each of the access points 104-110 may communicate with one or more network nodes (represented, for convenience, by network node 112) to facilitate wide area network connectivity. Such network nodes may take various forms such as, for example, one or more radio and/or core network entities (e.g., an operations and maintenance entity 114 or a mobility management entity), one or more access points, or other types of network entities.

Each access point in the system 100 may be assigned a first type of identifier, referred to herein as a node identifier. In various implementations such an identifier may comprise, for example, a physical cell identifier (“PCI”), a pseudorandom number (“PN”) offset, or an acquisition pilot. Typically, a fixed quantity (e.g., 504) of node identifiers is defined in a given system. In such a case, an identifier conflict may arise when multiple access points use the same identifier. In particular, an identifier conflict may arise in a network where a large number of small coverage access points are deployed within a given macro coverage area. In some aspects a conflicting use may involve identifier confusion where, for example, neighbor access points of a given access point use the same identifier. In some aspects a conflicting use may involve identifier collision where, for example, two access points in close proximity use the same identifier whereby a node in the vicinity of these access points may concurrently receive signals comprising the same identifier from each access point. In other words, a collision may be defined as a case where an identifier of an access point is not unique within the coverage area of that access point.

FIG. 1 illustrates a simple example where the access point 108 and the access point 110 are both assigned “identifier 1.” If the access points 108 and 110 are sufficiently close to one another, a wireless node (e.g., access terminal 102) in the system may be able to concurrently receive signals (e.g., pilot signals) encoded with the same identifier from both access points. Consequently, the wireless node may not be able to decode messages from either access point (e.g., since the channel the wireless node estimates from the concurrently received signals will not correspond to a channel associated with either access point). This form of identifier conflict may be referred to as identifier collision.

Identifier confusion may arise when two access points use the same identifier but are not close enough to one another to cause identifier collision. For example, as the access terminal 102 roams through the system 100, the access terminal 102 may be handed over from a source access point (i.e., the serving access point to which the access terminal 102 is currently connected, e.g., access point 104) to a target access point (e.g., access point 110). In a typical case, a decision to hand over the access terminal 102 to a target access point may be based on whether the access terminal 102 is receiving particularly strong signals (e.g., pilot signals) from that target.

In the example of FIG. 1, the access terminal 102 identifies signals from potential target access points by way of node identifiers associated with those signals (e.g., identifiers used to encode the signal). Upon receiving a signal from a potential target, the access terminal 102 may send a message (e.g., a measurement report) that includes the identifier associated with the signal to the current serving access point of the access terminal 102. If a decision is made to perform a handover, the serving access point (i.e., the source access point for the handover) may communicate with the target access point to reserve resources for the access terminal. For example, context information maintained by the serving access point may be transferred to the target access point and/or context information maintained by the target access point may be sent to the access terminal 102. In the absence of identifier confusion, the node identifier (“identifier 1”) associated with the target access point may be mapped to a unique identifier (e.g., a global cell identifier, GCI) associated with the target access point, whereby the unique identifier is used to establish communication with the target access point (e.g., based on a known mapping between the unique identifier and an IP address of the access point). When confusion does exist as in the example of FIG. 1, however, the source access point may not be able to determine which access point is the desired target access point (e.g., the access point 104 may not be able to determine whether to communicate with the access point 108 or the access point 110 to reserve resources for the access terminal 102).

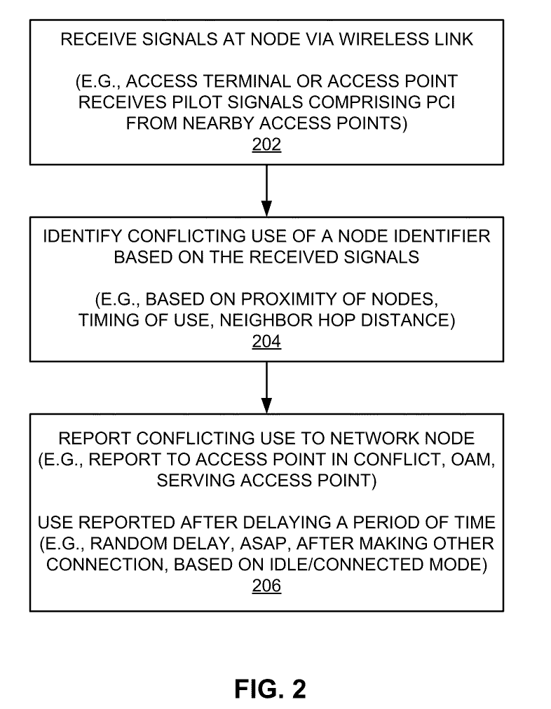

The disclosure relates in some aspects to techniques for identifying identifier conflict, techniques for reporting identifier conflict, and techniques for resolving identifier conflict. In some aspects the disclosed techniques relate to how identifier conflict is reported, when identifier conflict is reported, and steps taken upon receipt of a report of identifier conflict. These techniques will be described in detail in conjunction with the flowcharts of FIGS. 2-7.

For convenience, the operations of FIGS. 2-7 (or any other operations discussed or taught herein) may be described as being performed by specific components (e.g., components of the system 100). It should be appreciated, however, that these operations may be performed by other types of components and may be performed using a different number of components. It also should be appreciated that one or more of the operations described herein may not be employed in a given implementation.

FIG. 1 illustrates several sample components that may be incorporated into nodes such as the access terminal 102 and the access point 104 to perform identifier conflict-related operations as taught herein. The described components also may be incorporated into other nodes in a communication system. For example, other nodes in a system may include components similar to those described for the access terminal 102 and the access point 104 to provide similar functionality. A given node may contain one or more of the described components.

As shown in FIG. 1, the access terminal 102 and the access point 104 may include transceivers 116 and 118, respectively, for communicating with other nodes. The transceiver 116 includes a transmitter 120 for sending signals (e.g., messages such as conflict reports) and a receiver 122 for receiving signals (e.g., messages such as pilots comprising identifiers). Similarly, the transceiver 118 includes a transmitter 124 for sending signals (e.g., messages such as pilots, conflict reports, and conflict-related negotiations) and a receiver 126 for receiving signals (e.g., messages such as conflict reports, conflict-related negotiations, and pilots). The access terminal 102 and the access point 104 also may include other components that facilitate communication with other nodes. For example, the access terminal 102 and the access point 104 may include communication controllers (not shown for convenience) for managing communication with other nodes (e.g., sending and receiving messages/indications) and for providing other related functionality as taught herein.

The access terminal 102 and the access point 104 may include other components that may be used in conjunction with identifier conflict-related operations as taught herein. For example, the access terminal 102 and the access point 104 may include conflict identifiers 128 and 130, respectively, for identifying identifier conflict (e.g., sending, receiving, and processing signals/messages to identify and report conflict) and for providing other related functionality as taught herein. In addition, the access terminal 102 and the access point 104 may include identifier controllers 132 and 134, respectively, for managing identifiers (e.g., sending, receiving, and processing signals/messages to select and report identifiers) and for providing other related functionality as taught herein.

For convenience the access terminal 102 and the access point 104 are shown in FIG. 1 as including components that may be used in the various examples described below in conjunction with FIGS. 2-7. In practice, one or more of the illustrated components may not be used in a given example. As an example, in some implementations the access terminal 102 may not include the identifier controller 132.

Referring now to FIG. 2, this flowchart describes several operations that may be performed in conjunction with identifying and reporting a conflicting use of an identifier. In particular, the described operations may be performed by a node that may receive wireless signals.

As represented by block 202, a wireless node in the system 100 (FIG. 1) receives signals via a wireless link, wherein the signals comprise an indication of one or more node identifiers used by one or more access points. This operation may be performed by an access terminal and/or, in some cases, by an access point.

For example, during the course of normal operations the access terminal 102 may be configured to acquire pilot signals broadcast by access points in the vicinity. Thus, the access terminal 102 (e.g., receiver 122) may receive a first pilot signal from a first access point (where the first pilot is encoded with a PCI currently used by the first access point) and a second pilot signal from a second access point (where the second pilot is encoded with a PCI currently used by the second access point). In the example of FIG. 1, the access point 108 may comprise the first access point while the access point 110 may comprise the second access point.

In some cases an access point may be configured (e.g., with an appropriate radio configuration) to receive signals from other access points. For example, the access point 104 (e.g., receiver 126) may receive one or more pilot signals broadcast by one or more access points (e.g., access point 108 and/or access point 110).

As represented by block 204, the wireless node may identify conflicting use of a node identifier based on the received signal. Here, the wireless node may determine that two or more access points are using the same node identifier (e.g., the access points are using the same PCI value).

When the wireless node is the access terminal 102, the conflict identifier 128 may determine that two access points (e.g., access points 108 and 110) that do not hear one another are using the same identifier. Conversely, when the wireless node is the access point 104, the conflict identifier 130 may determine that two access points (e.g., access points 108 and 110) are using the same identifier, or that at least one other access point (e.g., access point 108 and/or 110) is using the same identifier as the access point 104.

Identification of a conflict may be based on one or more other factors in various implementations. One such factor may be the relative proximity of the access points. For example, in some cases a conflict (e.g., collision or confusion) may only be indicated when the nodes that use the same identifier are within a defined distance of one other. Another factor may be the relative timing of the identifier use by the access points. For example, in some cases a conflict may only be indicated if the same identifier is received from different nodes within a defined period of time. Another factor may depend on the hop distance between the access points. For example, in some cases a conflict may only be indicated if the same identifier is received from nodes that are one-hop neighbors or two-hop neighbors.

As represented by block 206, if a conflict is identified, the wireless node reports the conflicting use to one or more network nodes. For example, the access terminal 102 (e.g., the conflict identifier 128) or the access point 104 (e.g., the conflict identifier 130) may send an indication of the conflict to an access point, a core network node (e.g., operations and maintenance entity, OAM), some other type of node of a network, or some combination of one or more of these nodes.

In some cases the conflict report is sent to one or more of the nodes in conflict. In this way, one or more of these nodes may take action to resolve the conflict.

In some cases the conflict report is sent to an OAM. The OAM may then take appropriate action (e.g., communicate with the nodes in conflict) to resolve the conflict.

In a case where the wireless node is an access terminal, the access terminal may, for example, send the conflict report to the next access point to which the access terminal connects. In this case, this new serving access point for the access terminal may, for example, contact one or more of the nodes in conflict or the OAM to facilitate resolving the conflict.

In a case where the wireless node is one of the access points in conflict, the access point may, for example, send the conflict report to the other access point(s) in conflict. In this case, the access points may communicate (e.g., negotiate) to resolve the conflict.

The conflict indication may take various forms. In some cases the indication simply indicates that there is a conflict with a certain node identifier. Here, the indication may specify the node identifier. In some cases the indication may specify one or more of the nodes that are in conflict. For example, an indication sent to one conflicting node may indicate the other node(s) that is/are in conflict by including a unique identifier (e.g., a GCI) of each node with the indication.

In some implementations the wireless node may delay sending the conflict report. Under certain conditions, this technique may reduce the number of conflicts in the system.

For example, in the event of a power failure or some other widespread disruption in a network, when the access points (e.g., HeNBs) come back on-line they may independently (e.g., autonomously) select their node identifiers. In this case, there may initially be a large number of identifier conflicts. Moreover, a large number of wireless nodes in the network may detect these conflicts. Consequently, there is a possibility that there may be a flood of conflict reports from the wireless nodes in the network, many of which may be reporting the same identifier conflict (i.e., identifying the same access points in conflict) to different ones of the conflicting access points. This, in turn, may result in concurrent attempts by conflicting access points to resolve the conflicts. Since the access points may be changing their identifiers at the same time, there is a possibility that the access points may concurrently select another conflicting identifier (e.g., particularly when only a few identifiers are available for use). Thus, such a situation may result in relatively persistent identifier conflicts in the network.

Through the use of a delayed conflict reporting scheme as taught herein, the likelihood of persistent identifier conflicts such as this may be reduced. For example, since some of the conflict reports will be delayed more than others, at least some of the conflicts may be resolved before they are reported by some of the wireless nodes. Thus, these wireless nodes may end up not reporting the conflicts at all. Hence, fewer (e.g., only one) of the access points may change their identifiers to resolve the conflict, thereby reducing the likelihood that more than one of a set of access points in conflict will change its identifier in an attempt to resolve the conflict.

The delaying of conflict reports may be accomplished in different ways in different implementations. In some cases, the conflicting use is reported after delaying for a period of time after the identification of the conflicting use.

In some cases the period of time is a random period of time. Thus, different wireless nodes in the network may randomly elect different delay times so that there is a high probability that different nodes that see the same conflict will be scheduled to report the conflict at different times. In this way, the later scheduled reports may end up not being sent.

In some cases the period of time corresponds to as soon as the wireless node is able to report the conflicting use of the identifier (e.g., as soon as possible). For example, the conflicting use may be reported as soon as the wireless node is able to transmit a message.

In some cases the period of time corresponds to the next time the wireless node (e.g., an access terminal) makes a connection for a purpose other than reporting the conflicting use. For example, the conflicting use may be reported the next time an access terminal connects to its serving access point to make a call or to receive a message destined for the access terminal.

In some cases the duration of the period of time is based on whether the wireless node (e.g., an access terminal) is idle or is connected (or connecting). For example, an access terminal that is in a connected mode (e.g., connected or in the process of connecting) may be configured to immediately report the conflict (i.e., report as soon as possible). In contrast, an access terminal that is in an idle (e.g., power saving) mode may be configured to delay for a longer period of time before reporting the conflict. Here, an access terminal that is in conflict (e.g., seeing multiple access points with the same identifier) is unlikely to be connected. Hence, it may be more reliable for another node that is connected/connecting to report the conflict. This scheme also promotes system efficiency, since fewer operations may be required for a connected/connecting access terminal to send a report than for an idle access terminal to send a report (e.g., since the idle terminal would need to switch to active mode, then connect, and so on).

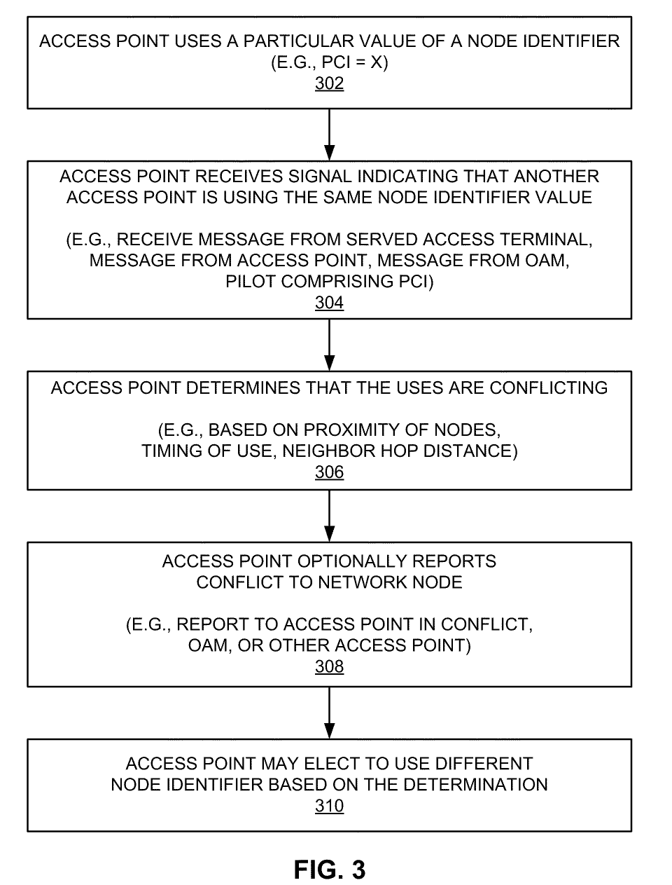

Referring now to FIG. 3, sample operations that may be performed by an access point in conjunction with identifying conflicting use of an identifier will be described. In this example, the access point determines whether the identifier it is using is in conflict with the identifier being used by one or more other access points.

As represented by block 302, at a given point in time an access point will use a particular value of a node identifier. For example, the access point 104 (e.g., identifier controller 134) may implement an algorithm for autonomously (or semi-autonomously) selecting an identifier. A brief explanation of a sample algorithm follows.

In a network that includes overlay (e.g., macro) access points and underlay access points (e.g., non-macro access points such as HeNBs), mutually exclusive sections of the available PCI space (e.g., 504 identifiers) may be assigned to the overlay access points on the one hand and the underlay access points on the other hand. Here, the identifiers assigned to the overlay access points may be planned while the identifiers assigned to the underlay access points may be self-configured (e.g., autonomously configured by each underlay access point). By splitting the PCI space, any underlay access points that select a conflicting identifier will not interfere with the operations of the overlay access points.

In various implementations, the specific set of identifiers allocated to the underlay access points may depend on geography and other factors. For example, to obtain a list of allowed identifiers, an underlay access point may provide location information to an appropriate network entity (e.g., a configuration server such as an OAM). The network entity may then provide the list based on the operator configuration.

An underlay access point may self-configure its identifier in various ways. A primary objective of a self-configuration algorithm is to select an identifier that does not cause a conflict with another underlay access point. In practice, however, the number of identifiers allocated for the underlay access points may be relatively small (e.g., tens of identifiers) compared to the number of underlay access points in a given area (e.g., possibly hundreds or more). Thus, as part of self-configuration, the underlay access point may attempt to determine the identifiers used by its neighbor access points.

In general, an access point may discover the identifiers used by its neighbors by: 1) receiving signals from nearby access points; 2) receiving reports from served access terminals; 3) directly communicating with the neighbors (e.g., via the backhaul); or 4) communicating with an appropriate network node (e.g., an OAM). In the first case, an access point with appropriate receiver technology may receive broadcast signals (e.g., comprising PCIs and GCIs) from nearby access points. In the second case, an associated access terminal may monitor for signals (e.g., pilots) from nearby access points and send reports (e.g., measurement reports) to the access point, where the reports include the identifiers used by the nearby access points. In the third case, an access point may establish neighbor relations with its neighbors over the backhaul and exchange information including the identifiers that are currently in use (e.g., establish communication by using known mapping between GCI and IP address). In the fourth case, a network node may maintain a list of the identifiers used by access points in the network, whereby an access point may request identifier information for all access points in, for example, a given area. In cases 1, 2, and 4, the access point also may conduct neighbor relations with any discovered access points, if this is desired. In addition, if the access point learns of a new two-hop (or three-hop, etc.) neighbor, the access point also may conduct neighbor relations with this access point.

In some implementations an access point may categorize (i.e., group) its neighbors as a means to identify identifiers that the access point should not select, should select, or may select. A sample algorithm follows. Initially, the access point may attempt to find (e.g., randomly select) an identifier that lies within the valid set of identifiers and that does not belong to any of these groups. If this is not possible, if confusion is allowed, the access point may select (e.g., randomly) any identifier from the list. If confusion is not allowed, the access point may use the groups to select an identifier. For example, a first group of identifiers may include those from neighbor access points that were heard by the access point or that were reported by access terminals that are being served by that access point. In some cases, the access point may be configured to never select an identifier from this group. A second group of identifiers may comprise the two-hop neighbors of neighboring underlay access points. Again, in some cases the access point may be configured to never select an identifier from this group. A third group of identifiers may comprise the two-hop neighbors of neighboring overlay access points. The access point may be configured to select an identifier from this group if one is available. If an identifier is not available, the self-configuration process may be aborted.

Referring again to the conflict detection scheme of FIG. 3, as represented by block 304, at some point in time the access point 104 (e.g., the conflict identifier 130) receives a signal that indicates that one or more other access points are using the same node identifier as the access point 104. The access point 104 may receive this signal in any of the ways discussed above. Thus, the access point 104 may receive a pilot or other signal from one or more access points via a wireless link wherein the signal includes the identifier information of another access point. In addition, the access point 104 may conduct neighbor relations over the backhaul and receive a message from one or more access points. Here, the access point 104 may receive identifier information directly from another access point or the access point 104 may receive identifier information about another access point indirectly from a third access point. The access point 104 also may receive a message via a wireless link from one or more of the access terminals served by the access point 104, wherein the message includes the identifier information of another access point. In addition, the access point 104 may receive a message from a network entity (e.g., the OAM) that maintains a record of the identifier information used by access points in the network.

As represented by block 306, the access point 104 (e.g., the conflict identifier 130) may then determine whether the uses of this identifier are conflicting. As discussed above in conjunction with block 204, this determination may optionally be based on one or more additional factors (e.g., proximity, timing, hop distance).

As represented by block 308, in some implementations the access point 104 (e.g., the conflict identifier 130) may report the conflicting use to one or more network nodes. For example, as discussed above in conjunction with block 206, the access point 104 may send a message to the other conflicting access point(s), to the OAM, or to some other access point (e.g., which may forward the information to one or more conflicting access points).

In addition, as represented by block 310, the access point 104 (e.g., the identifier controller 134) also may elect to use a different node identifier as a result of the determination of block 306. For example, the access point 104 may select an identifier in a similar manner as discussed above in conjunction with block 302. In this case, however, the access point 104 will have an additional constraint of not selecting the identifier that is currently in conflict.

As a specific example of the operations of FIG. 3, the access terminal 102 may receive pilots comprising the same PCI value from the access point 104 and another access point that is two hops away from the access point 104. Consequently, the access terminal may send a conflict report to the access terminal 104, including the GCI of the other access point. The access point 104 may then send a neighbor information request to the other access point, whereby the other access point sends a response including the PCI it uses and its neighbor list information. Thus, the access point 104 may discover that another access point (e.g., in group 1 or group 2 discussed above) is using the same PCI as the access point 104. In addition, with the arrival of this neighbor list, the access point 104 may send neighbor information requests to each of the access points in the neighbor list. In this way, the access point 104 may discover the PCIs used by these multi-hop neighbors for use in future PCI conflict resolution operations. Finally, the access point 104 may elect to use a different PCI to resolve the detected conflict.

As discussed above, in a network where access points self-configure their node identifiers, it is possible that two access points that are in conflict will each change their identifiers with the result that the access points remain in conflict, albeit with a different identifier. For example, two access terminals may independently receive pilots from a first access point and a second access point that use the same PCI. A first one of the access terminals may send a conflict report to the first access point while a second one of the access terminals sends a conflict report to the second access point. Each of the access points may then independently send a neighbor information request to the other access point and receive a response that confirms the use of the same PCI. In this case, each of the access points may independently elect to use a different PCI. However, it is possible that the access points may switch to the same PCI (particularly if only a few identifiers are available).

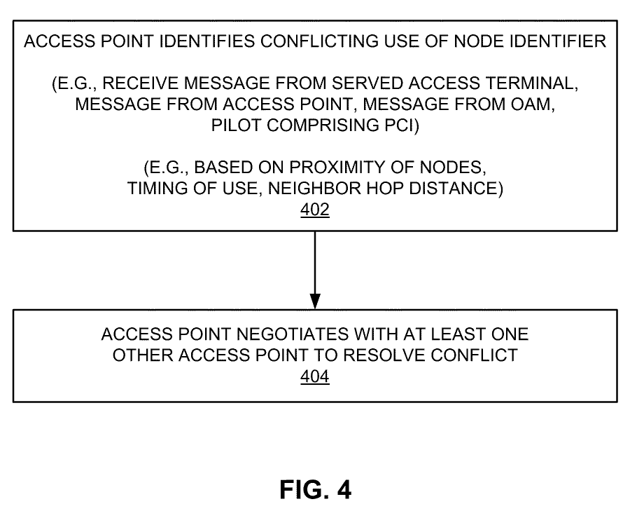

To avoid such a situation, in some implementations the operations of block 308 and, optionally, block 310 may involve negotiating with at least one conflicting access point to resolve the conflict. Sample operations of such a communication scheme will now be described in conjunction with FIGS. 4-6. Since the access points in this case are in communication with one another, each access point may determine the current state (e.g., the currently used identifier) of the other access point. Consequently, such a scheme may be referred to as a stateful conflict resolution scheme.

As represented by block 402, an access point identifies a conflicting use of a node identifier as discussed above in conjunction with blocks 302-306. Thus, the access point 104 (e.g., the conflict identifier 130) may receive signals from an access point, an access terminal, an OAM, etc., and optionally identify a conflict based on proximity, timing, neighbor hops, etc.

As represented by block 404, once a conflict is identified, the access point 104 (e.g., the identifier controller 134) may communicate with at least one access point to resolve the conflict. For example, the access point 104 may negotiate with the other access point over the backhaul, whereby the access point 104 or the other access point may elect to use another identifier.

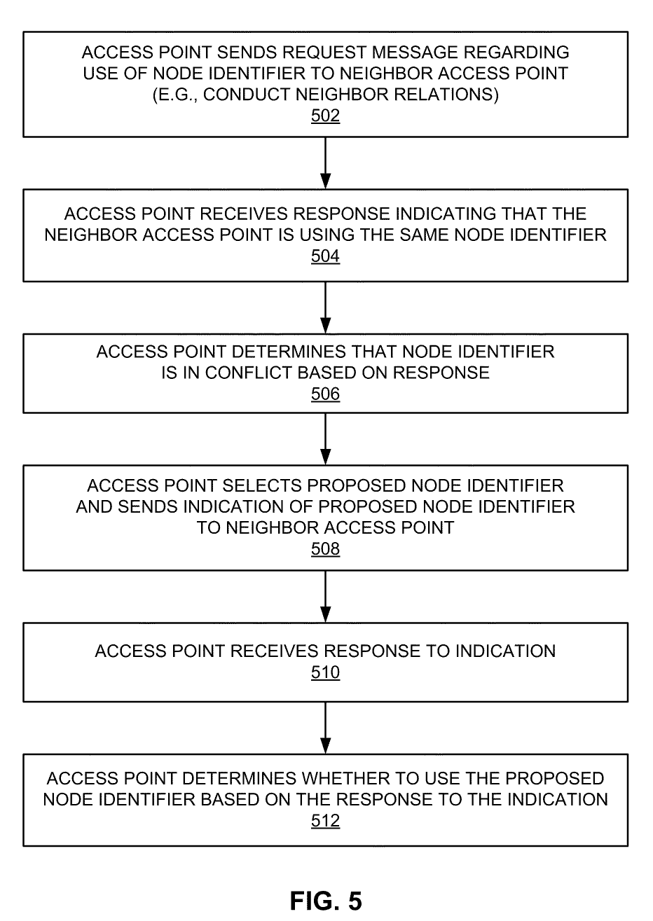

FIG. 5 describes sample conflict identification and negotiation procedures where, instead of immediately changing its node identifier, a first access point may delay changing its node identifier until after negotiating with a second access point. Here, the first access point informs the second access point of an intent to switch to a different identifier. The first access point may then determine whether to switch to the different identifier based on the response received from the second access point.

Blocks 502-506 describe an example of the operations of block 402. It should be appreciated that a conflict may be identified in some other manner in accordance with the teachings herein. In this example, as represented by block 502, a first access point may send a message (e.g., a neighbor information request) to a second access point requesting that the second access point provide a response that indicates the identifier currently being used by the second access point. In some cases the message may include an indication of the identifier used by the first node. In some cases, the first access point may send this message upon receiving a conflict report from an access terminal that indicates that the second access point uses the same identifier as the first access point. As represented by block 504, the second access point sends the requested response (e.g., a neighbor information response). Thus, the first access point may confirm that these access points are using the same identifier. As represented by block 506, the first access point may thus determine that there is conflicting use of the node identifier (e.g., as discussed herein).

Blocks 508-512 describe an example of the operations of block 404. It should be appreciated that negotiations between nodes may be conducted in some other manner in accordance with the teachings herein.

In this example, as represented by block 508, the first access point selects a proposed node identifier (i.e., different than the identifier currently being used by the first access point). This selection may be made, for example, in a similar manner as described above at block 302. The first access point then sends an indication of this node identifier (e.g., an InConfig value) to the second access point (e.g., via a PCI resolution request).

At this point the first access point has not yet changed its node identifier. For example, the first access point may still be broadcasting pilot signals comprising the PCI that was deemed to be in conflict at block 506.

However, the first access point will respond to any node identifier queries (e.g., neighbor information requests or PCI resolution requests) received by the first access point during this transition period with an indication that the first access point is intending to switch to the proposed node identifier. For example, the PCI value in any neighbor information responses or PCI resolution responses sent during this period of time will be set to the InConfig value. In this case, the node that sent the query may invoke a random backoff (e.g., delay for a random period of time) before retrying the query.

As represented by block 510, the first access point receives the response from the second access point (e.g., a PCI resolution response). In some cases this response may indicate whether the first access point may switch to the proposed node identifier. For example, if the second access point is intending to switch to that same value, the second access point may indicate that the first access point should not switch. Also, the second access point may be aware of one or more nearby access points that are using or are likely to use the proposed node identifier (e.g., based on a neighbor list). In this case, the second access point also may indicate that the first access point should not switch. If, on the other hand, the second access point is not aware of any conflicts (and, optionally, potential conflicts), the second access point may indicate that the first access point may switch. In some cases the response also may include the node identifier currently being used by the second access point.

As represented by block 512, the first access point determines whether to use the proposed node identifier based on the response. In the event the first access point changes its node identifier, the first access point may send a message to the second access point confirming the change to the proposed node identifier. In the event the first access point does not change to the proposed node identifier (e.g., due to a negative response at block 510), the first access point may invoke a random backoff before retrying.

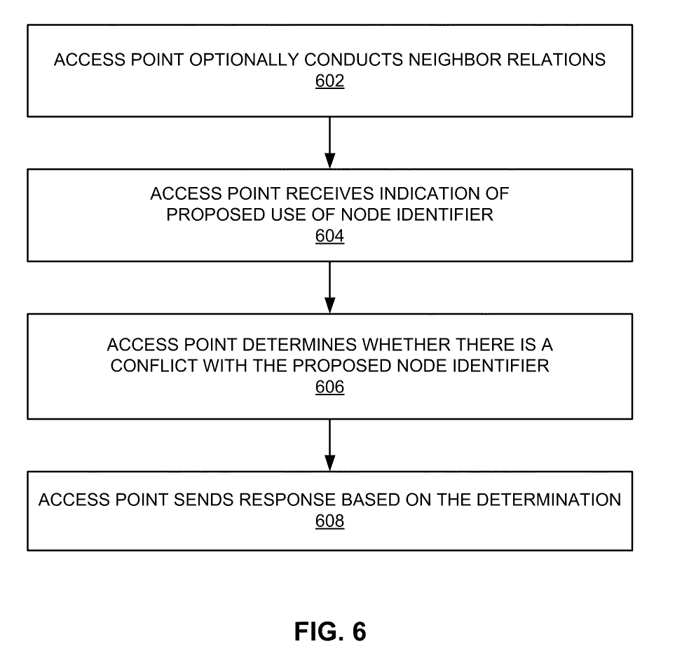

FIG. 6 describes several complementary operations that may be performed by the second access point in the example of FIG. 5. As represented by block 602, the second access point may conduct neighbor relation operations similar to those described above at blocks 502 and 504. As represented by block 604, the second access point receives an indication of a proposed use of a node identifier (e.g., a PCI resolution request specifying an InConfig value) from the first access point. As represented by block 606, the second access point determines whether there is a conflict (or potential conflict) with the proposed node identifier (e.g., as discussed above at block 510). As represented by block 608, the second access point then sends a response (e.g., a PCI resolution response including the second access point's PCI) to the first access point based on the determination of block 606.

In some implementations, if the second access point receives a PCI resolution request from the first access point specifying an InConfig value that is the same as the second access point's current PCI value, the second access point may elect to back off to a prior PCI value (e.g., a value from which the second access point recently changed). The second access point may then invoke a random backoff before attempting to do its own PCI resolution request. In this way, the probability of both access points switching to the same value may be reduced (e.g., particularly where there is a small number of available PCIs).

In some cases it may not be possible for conflicting access points to coordinate with one another to resolve an identifier conflict. For example, an access terminal that detects a PCI collision may not be able to receive the GCIs of the conflicting access points. Hence, an access point that receives a conflict report from that access terminal may not be able to communicate with a conflicting access point.

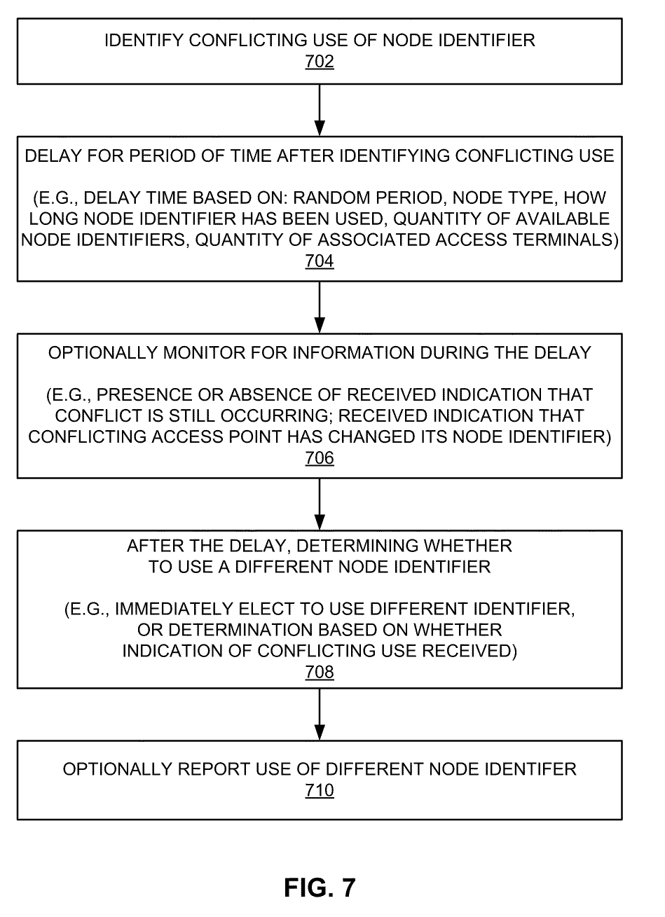

FIG. 7 describes a scheme where, after identifying a conflict, an access point may autonomously delay for a period of time before determining whether to use a different node identifier. Through the use of such a scheme, the manner in which access points in a network change node identifiers may be advantageously controlled. Since the access points in this case may not be able to determine the current state (e.g., the currently used identifier) of the other access point, such a scheme may be referred to as a stateless conflict resolution scheme.

As represented by block 702, an access point may identify a conflicting use of a node identifier as discussed herein. For example, the access point 104 (e.g., the conflict identifier 130) may perform operations similar to those described above at blocks 302-306 and thereby determine that at least one other access point is using the same node identifier as the access point 104. As a specific example, the access point 104 may receive a conflict report from an access terminal that is served by the access point 104.

As represented by block 704, the access point 104 (e.g., the identifier controller 134) delays for a period of time after identifying the conflicting use. For example, the delay period may commence upon receipt of the first conflict report.

As represented by block 706, the access point 104 (e.g., the identifier controller 134) may optionally monitor for information after the identification of the conflicting use (e.g., during the delay). In particular, the access point 104 may monitor for information that indicates whether the conflict detected at block 702 still exists. Information collected during this time may include, for example, the presence or absence of received conflict reports during the delay period and/or receipt of an indication that a conflicting node has changed its identifier.

As represented by block 708, after the delay period ends, the access point 104 (e.g., the identifier controller 134) determines whether to use a different node identifier. In some cases, the access point 104 may make this decision immediately (i.e., as soon as possible) upon expiration of the delay.

In other cases, however, the decision to use a different node identifier may be based on the information collected or not collected during the delay as represented by block 706. For example, if it can be determined that the conflict no longer exists (e.g., based on receipt of an indication that a conflicting node has changed its node identifier), the access point 104 may elect to not change its node identifier. Similarly, if it can be estimated with relatively high probability that the conflict no longer exists (e.g., based on the lack of receipt of any more conflict reports), the access point 104 may elect to not change its node identifier. Conversely, if any additional conflict reports were received, the access point 104 may elect to change its node identifier.

In some implementations the access point 104 may base its decision to use a different node identifier on conditions that exist after the delay has expired. For example, in some cases the access point 104 may only change its node identifier if it receives an indication of the conflicting use (e.g. a conflict report) after the expiration of the delay period. This indication may be received, for example, in any of the previously mentioned ways (e.g., from an access point, an access terminal, an OAM, and so on).

As represented by block 710, if a decision is made to use a different identifier, the access point 104 (e.g., the identifier controller 134) may report this change to one or more nodes in the network. For example, this change may be reported to any neighboring nodes (e.g., potentially including multi-hop neighbors), to an OAM, and so on. In addition, if possible this change may be reported to any conflicting access points (which may have a longer delay period than the access point 104 and, hence, may use this indication to avoid changing its node identifier).

The delay of block 704 may take various forms and may be based on various factors in different implementations. Advantageously, by causing different access points to delay for different amounts of time, fewer access points in the network may switch to different node identifiers when identifier conflicts arise. For example, in a case where two access points use the same node identifier and both access points are informed of the conflict, a first access point that delays for a shorter period of time may switch to a different node identifier (e.g., since the first access point may have received a conflict report after the expiration of its delay) well before the longer delay period of the second access point expires. Consequently, before this longer delay period expires, the second access point may be able to discover that the conflict no longer exists. Thus, the second access point may avoid changing its node identifier.

Moreover, as discussed in more detail below, some degree of control may be exercised over which access points will likely change their node identifiers when an identifier conflict arises and which access points will likely not change their node identifiers when an identifier conflict arises. Accordingly, service disruptions that may otherwise result from changes in node identifiers may be reduced for certain access points in the network by assigning longer delay periods to those access points.

In some implementations the delay time comprises a random delay. For example, each access point in the network may delay for a random period of time. In this case, there may be a high probability that different access points in the network will delay for different amounts of time.

In some implementations the delay time is based on (e.g., weighted based on) a node type. For example, certain types of nodes may be configured to delay for a longer period of time than other types of nodes. As a specific example, overlay (e.g., macro) access points may be configured to delay for a longer period of time than underlay (e.g., non-macro) access points. In this way, in the event there is an identifier conflict between an overlay and an underlay access point, the underlay access point may be configured to be much more likely to change its node identifier (e.g., by assigning a much shorter delay time) than the overlay access point.

In some implementations the delay time is based on (e.g., weighted based on) how long a node has used a node identifier. For example, when an access point identifies an identifier conflict, the access point may execute an algorithm that calculates a delay time based on how long that access point has used the node identifier or a lookup table may be employed that maps node identifier use time to delay time. Here, the use time may be inversely related to the delay time. In this way, an access point that has used a node identifier for a long period of time may be much less likely to have to change its node identifier than an access point that has not used its node identifier very long.

In some implementations the delay time is based on (e.g., weighted based on) the quantity of node identifiers that are available (e.g., unoccupied) for use by a node. In this case, when an access point identifies an identifier conflict, the access point may determine how many node identifiers are available and then execute an algorithm (or use a lookup table) to determine a delay time based on the number of available node identifiers. Here, the number of available node identifiers may be inversely related to the delay time. In this way, an access point that does not have very many available node identifiers (and, hence, is more likely to have another conflict if it changes its node identifier) may be much less likely to have to change its node identifier than an access point that has a larger number of available node identifiers.

In some implementations the delay time is based on (e.g., weighted based on) the quantity of access terminals associated with a node. Here, when an access point identifies an identifier conflict, the access point may determine the quantity of associated access terminals and then execute an algorithm (or use a lookup table) to determine a delay time based on this. In this case, the quantity of associated access terminals may be related to the delay time. In this way, an access point that has a large number of associated access terminals (and, hence, would require a large number of connections to be torn down and restarted if it changes its node identifier) may be much less likely to have to change its node identifier than an access point that has relatively few associated access terminals.

The number of associated access terminals may be calculated in various ways. For example, in some cases the quantity of currently associated access terminals may be used. In some cases the average quantity of associated access terminals over a period of time may be used. In some cases the quantity of currently connected access terminals may be used.

In some implementations various aspects of the above examples may be combined. For example, an access point may advertise a proposed node identifier and then wait a period of time (e.g., a random period of time) before deciding whether to use the proposed node identifier.

Also, a delay may be random, but weighted (e.g., based on at least one characteristic associated with at least one access point). For example, a first access point (e.g., associated with a lower weight) may select a random delay number between 1 second and 10 seconds while a second access point (e.g., associated with a higher weight) may select a random delay number between 1 second and 60 seconds (or between 11 and 60 seconds). Thus, in cases where the delay time is based on one or more of the above criteria (e.g., node type, how long a node has used a node identifier, the quantity of node identifiers that are available, the quantity of access terminals associated with a node) or some other criteria, this criteria may be used to determine which set of delay values are to be used to randomly select a delay time. As a specific example, an access point that has used a node identifier for a long period of time (and/or that does not have very many available node identifiers) may select a random time from the set of delay values between 11 and 60 seconds, while an access point that has not used a node identifier for a long period of time (and/or that has a relatively large number of available node identifiers) may select a random time from the set of delay values between 1 second and 10 seconds.

As mentioned above, the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (“AT”) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience). A node (e.g., an access point) that provides coverage over a relatively large area may be referred to as a macro node while a node that provides coverage over a relatively small area (e.g., a residence) may be referred to as a femto node. Similar principles may be applicable to nodes associated with other types of coverage areas. For example, a pico node may provide coverage (e.g., coverage within a commercial building) over an area that is smaller than a macro area and larger than a femto area.

In various applications, other terminology may be used to reference a macro node, a femto node, or other access point-type nodes. For example, a macro node may be configured or referred to as an access node, base station, access point, eNodeB, macro cell, and so on. Also, a femto node may be configured or referred to as a Home NodeB, Home eNodeB, access point base station, femto cell, and so on. In some implementations, a node may be associated with (e.g., divided into) one or more cells or sectors. A cell or sector associated with a macro node, a femto node, or a pico node may be referred to as a macro cell, a femto cell, or a pico cell, respectively.

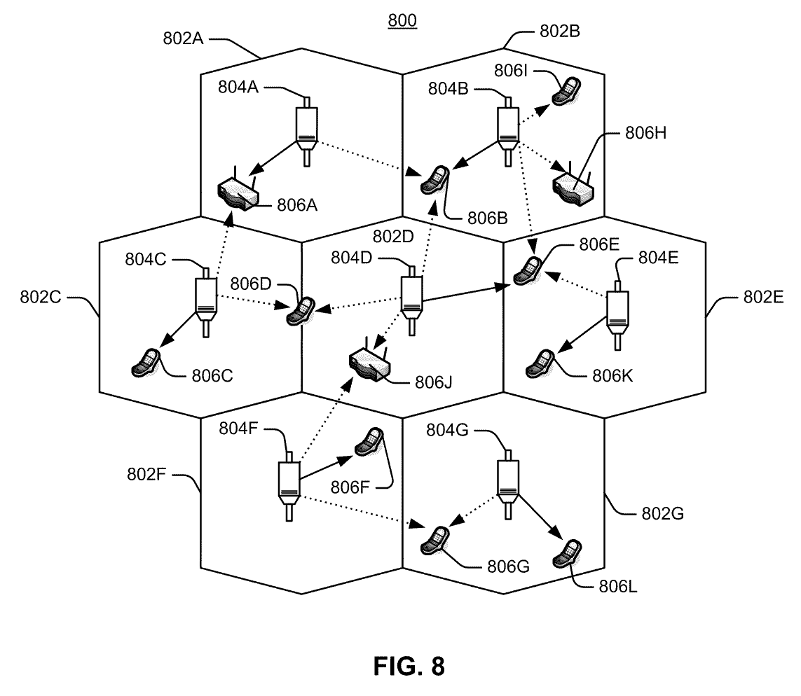

FIG. 8 illustrates a wireless communication network 800, configured to support a number of users, in which the teachings herein may be implemented. The system 800 provides communication for multiple cells 802, such as, for example, macro cells 802A-802G, with each cell being serviced by a corresponding access point 804 (e.g., access points 804A-804G). As shown in FIG. 8, access terminals 806 (e.g., access terminals 806A-806L) may be dispersed at various locations throughout the system over time. Each access terminal 806 may communicate with one or more access points 804 on a forward link (“FL”) and/or a reverse link (“RL) at a given moment, depending upon whether the access terminal 806 is active and whether it is in soft handoff, for example. The wireless communication network 800 may provide service over a large geographic region. For example, macro cells 802A-802G may cover a few blocks in a neighborhood or several miles in rural environment.

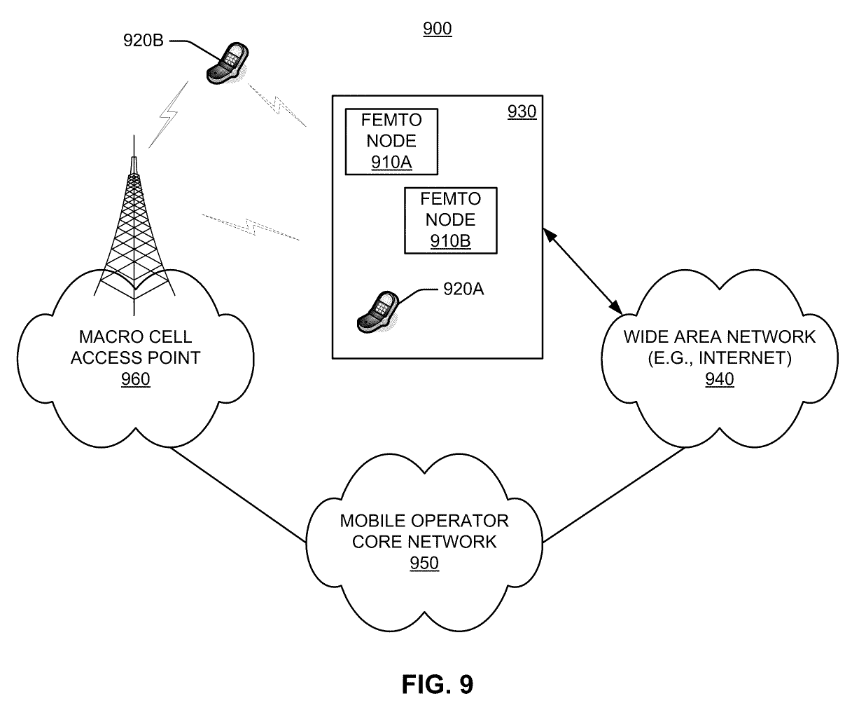

FIG. 9 illustrates an exemplary communication system 900 where one or more femto nodes are deployed within a network environment (e.g., network 800). Specifically, the system 900 includes multiple femto nodes 910 (e.g., femto nodes 910A and 910B) installed in a relatively small scale network environment (e.g., in one or more user residences 930). Each femto node 910 may be coupled to a wide area network 940 (e.g., the Internet) and a mobile operator core network 950 via a DSL router, a cable modem, a wireless link, or other connectivity means (not shown). As will be discussed below, each femto node 910 may be configured to serve associated access terminals 920 (e.g., access terminal 920A) and, optionally, other (e.g., hybrid or alien) access terminals 920 (e.g., access terminal 920B). In other words, access to femto nodes 910 may be restricted whereby a given access terminal 920 may be served by a set of designated (e.g., home) femto node(s) 910 but may not be served by any non-designated femto nodes 910 (e.g., a neighbor's femto node 910).

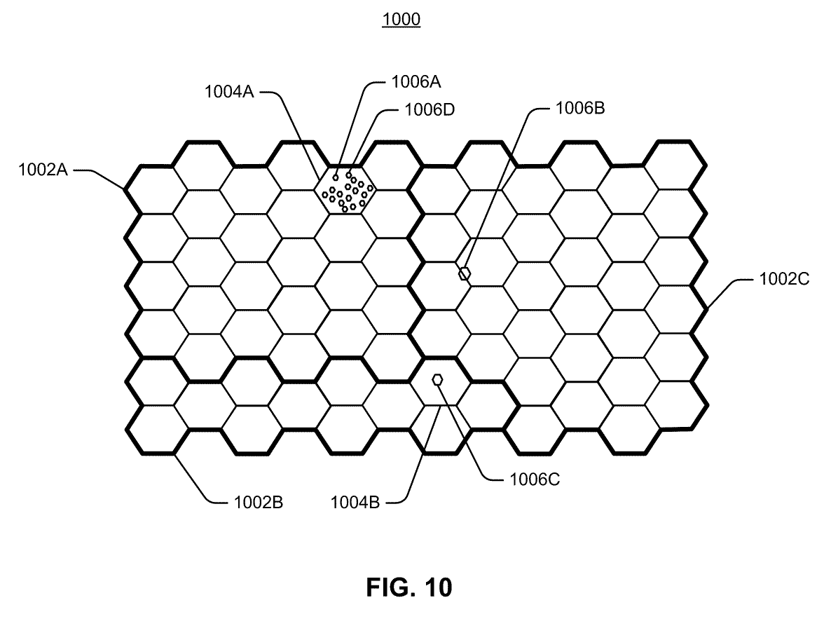

FIG. 10 illustrates an example of a coverage map 1000 where several tracking areas 1002 (or routing areas or location areas) are defined, each of which includes several macro coverage areas 1004. Here, areas of coverage associated with tracking areas 1002A, 1002B, and 1002C are delineated by the wide lines and the macro coverage areas 1004 are represented by the larger hexagons. The tracking areas 1002 also include femto coverage areas 1006. In this example, each of the femto coverage areas 1006 (e.g., femto coverage area 1006C) is depicted within one or more macro coverage areas 1004 (e.g., macro coverage area 1004B). It should be appreciated, however, that some or all of a femto coverage area 1006 may not lie within a macro coverage area 1004. In practice, a large number of femto coverage areas 1006 may be defined with a given tracking area 1002 or macro coverage area 1004. Also, one or more pico coverage areas (not shown) may be defined within a given tracking area 1002 or macro coverage area 1004.

Referring again to FIG. 9, the owner of a femto node 910 may subscribe to mobile service, such as, for example, 3G mobile service, offered through the mobile operator core network 950. In addition, an access terminal 920 may be capable of operating both in macro environments and in smaller scale (e.g., residential) network environments as discussed above. In other words, depending on the current location of the access terminal 920, the access terminal 920 may be served by a macro cell access point 960 associated with the mobile operator core network 950 or by any one of a set of femto nodes 910 (e.g., the femto nodes 910A and 910B that reside within a corresponding user residence 930). For example, when a subscriber is outside his home, he is served by a standard macro access point (e.g., access point 960) and when the subscriber is at home, he is served by a femto node (e.g., node 910A). Here, a femto node 910 may be backward compatible with legacy access terminals 920.

A femto node may be restricted in some aspects. For example, a given femto node may only provide certain services to certain access terminals. In deployments with so-called restricted (or closed) association, a given access terminal may only be served by the macro cell mobile network and a defined set of femto nodes (e.g., the femto nodes 910 that reside within the corresponding user residence 930). In some implementations, a node may be restricted to not provide, for at least one node, at least one of: signaling, data access, registration, paging, or service.

In some aspects, a restricted femto node (which may also be referred to as a Closed Subscriber Group Home NodeB) is one that provides service to a restricted provisioned set of access terminals. This set may be temporarily or permanently extended as necessary. In some aspects, a Closed Subscriber Group (“CSG”) may be defined as the set of access points (e.g., femto nodes) that share a common access control list of access terminals.

For convenience, the disclosure herein describes certain functionality in the context of a femto node. It should be appreciated, however, that a pico node or other type of node may provide the same or similar functionality for a different (e.g., larger) coverage area. For example, a pico node may be restricted, a home pico node may be defined for a given access terminal, and so on.

The teachings herein may be implemented in a wireless multiple-access communication that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (“MIMO”) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

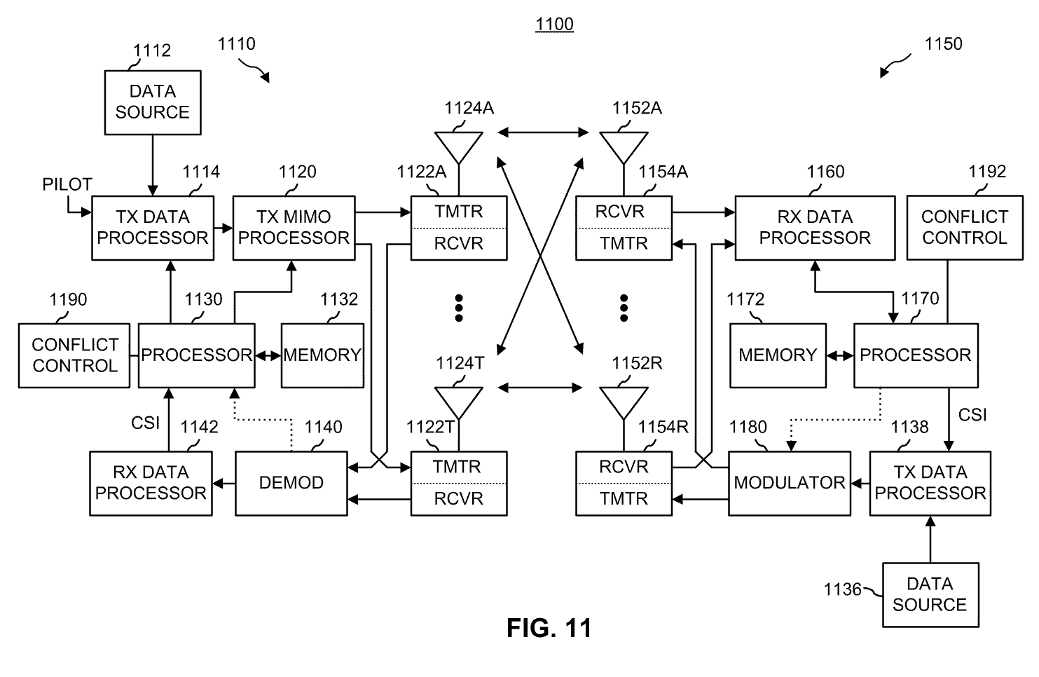

The teachings herein may be incorporated into a node (e.g., a device) employing various components for communicating with at least one other node. FIG. 11 depicts several sample components that may be employed to facilitate communication between nodes. Specifically, FIG. 11 illustrates a wireless device 1110 (e.g., an access point) and a wireless device 1150 (e.g., an access terminal) of a MIMO system 1100. At the device 1110, traffic data for a number of data streams is provided from a data source 1112 to a transmit (“TX”) data processor 1114.

In some aspects, each data stream is transmitted over a respective transmit antenna. The TX data processor 1114 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1130. A data memory 1132 may store program code, data, and other information used by the processor 1130 or other components of the device 1110.

The modulation symbols for all data streams are then provided to a TX MIMO processor 1120, which may further process the modulation symbols (e.g., for OFDM). The TX MIMO processor 1120 then provides N_{T} modulation symbol streams to N_{T} transceivers (“XCVR”) 1122A through 1122T. In some aspects, the TX MIMO processor 1120 applies beam-forming weights to the symbols of the data streams and to the antenna from which the symbol is being transmitted.

Each transceiver 1122 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1122A through 1122T are then transmitted from N_{T} antennas 1124A through 1124T, respectively.

At the device 1150, the transmitted modulated signals are received by N_{R} antennas 1152A through 1152R and the received signal from each antenna 1152 is provided to a respective transceiver (“XCVR”) 1154A through 1154R. Each transceiver 1154 conditions (e.g., filters, amplifies, and downconverts) a respective received signal, digitizes the conditioned signal to provide samples, and further processes the samples to provide a corresponding “received” symbol stream.

A receive (“RX”) data processor 1160 then receives and processes the N_{R} received symbol streams from N_{R} transceivers 1154 based on a particular receiver processing technique to provide N_{T} “detected” symbol streams. The RX data processor 1160 then demodulates, deinterleaves, and decodes each detected symbol stream to recover the traffic data for the data stream. The processing by the RX data processor 1160 is complementary to that performed by the TX MIMO processor 1120 and the TX data processor 1114 at the device 1110.

A processor 1170 periodically determines which pre-coding matrix to use (discussed below). The processor 1170 formulates a reverse link message comprising a matrix index portion and a rank value portion. A data memory 1172 may store program code, data, and other information used by the processor 1170 or other components of the device 1150.

The reverse link message may comprise various types of information regarding the communication link and/or the received data stream. The reverse link message is then processed by a TX data processor 1138, which also receives traffic data for a number of data streams from a data source 1136, modulated by a modulator 1180, conditioned by the transceivers 1154A through 1154R, and transmitted back to the device 1110.

At the device 1110, the modulated signals from the device 1150 are received by the antennas 1124, conditioned by the transceivers 1122, demodulated by a demodulator (“DEMOD”) 1140, and processed by a RX data processor 1142 to extract the reverse link message transmitted by the device 1150. The processor 1130 then determines which pre-coding matrix to use for determining the beam-forming weights then processes the extracted message.

FIG. 11 also illustrates that the communication components may include one or more components that perform conflict control operations as taught herein. For example, a conflict control component 1190 may cooperate with the processor 1130 and/or other components of the device 1110 to send/receive signals to/from another device (e.g., device 1150) as taught herein. Similarly, a conflict control component 1192 may cooperate with the processor 1170 and/or other components of the device 1150 to send/receive signals to/from another device (e.g., device 1110). It should be appreciated that for each device 1110 and 1150 the functionality of two or more of the described components may be provided by a single component. For example, a single processing component may provide the functionality of the conflict control component 1190 and the processor 1130 and a single processing component may provide the functionality of the conflict control component 1192 and the processor 1170.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (“CDMA”) systems, Multiple-Carrier CDMA (“MCCDMA”), Wideband CDMA (“W-CDMA”), High-Speed Packet Access (“HSPA,” “HSPA+”) systems, Time Division Multiple Access (“TDMA”) systems, Frequency Division Multiple Access (“FDMA”) systems, Single-Carrier FDMA (“SC-FDMA”) systems, Orthogonal Frequency Division Multiple Access (“OFDMA”) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (“UTRA)”, cdma2000, or some other technology. UTRA includes W-CDMA and Low Chip Rate (“LCR”). The cdma2000 technology covers IS-2000, IS-95 and IS-856 standards. A TDMA network may implement a radio technology such as Global System for Mobile Communications (“GSM”). An OFDMA network may implement a radio technology such as Evolved UTRA (“E-UTRA”), IEEE 802.11, IEEE 802.16, IEEE 802.20, Flash-OFDM®, etc. UTRA, E-UTRA, and GSM are part of Universal Mobile Telecommunication System (“UMTS”). The teachings herein may be implemented in a 3GPP Long Term Evolution (“LTE”) system, an Ultra-Mobile Broadband (“UMB”) system, and other types of systems. LTE is a release of UMTS that uses E-UTRA. Although certain aspects of the disclosure may be described using 3GPP terminology, it is to be understood that the teachings herein may be applied to 3GPP (Re199, Re15, Re16, Re17) technology, as well as 3GPP2 (1×RTT, 1×EV-DO RelO, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (“RNC”), a base station (“BS”), a radio base station (“RBS”), a base station controller (“BSC”), a base transceiver station (“BTS”), a transceiver function (“TF”), a radio transceiver, a radio router, a basic service set (“BSS”), an extended service set (“ESS”), a macro cell, a macro node, a Home eNB (“HeNB”), a femto cell, a femto node, a pico node, or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

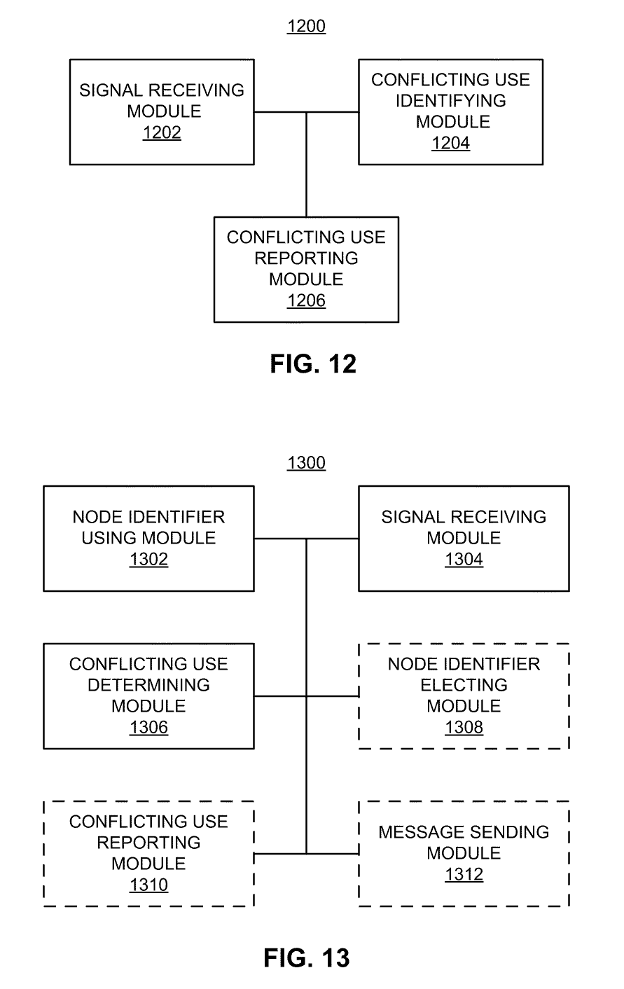

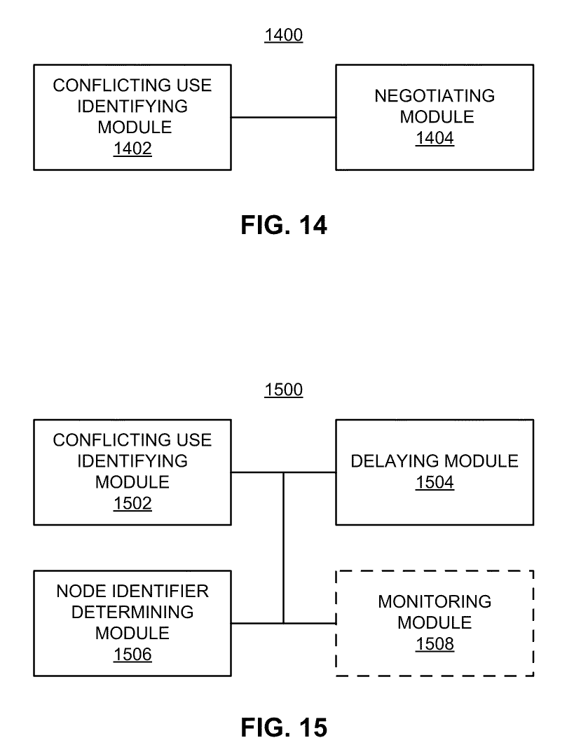

The functionality described herein (e.g., with regard to one or more of the accompanying figures) may correspond in some aspects to similarly designated “means for” functionality in the appended claims. Referring to FIGS. 12-15, apparatuses 1200, 1300, 1400, and 1500 are represented as a series of interrelated functional modules. Here, a signal receiving module 1202 may correspond at least in some aspects to, for example, a receiver as discussed herein. A conflicting use identifying module 1204 and/or a conflicting use reporting module 1206 may correspond at least in some aspects to, for example, a conflict identifier as discussed herein. A node identifier using module 1302 and/or a node identifier electing module 1308 may correspond at least in some aspects to, for example, an identifier controller as discussed herein. One or more of a signal receiving module 1304, a conflicting use determining module 1306, a conflicting use reporting module 1310, or a message sending module 1312 may correspond at least in some aspects to, for example, a conflict identifier as discussed herein. A conflicting use identifying module 1402 may correspond at least in some aspects to, for example, a conflict identifier as discussed herein. A negotiating module 1404 may correspond at least in some aspects to, for example, an identifier controller as discussed herein. A conflicting use identifying module 1502 may correspond at least in some aspects to, for example, a conflict identifier as discussed herein. One or more of a delaying module 1504, a node identifier determining module 1506, or a monitoring module 1508 may correspond at least in some aspects to, for example, an identifier controller as discussed herein.

The functionality of the modules of FIGS. 12-15 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein. In some aspects one or more of any dashed blocks in FIGS. 12-15 are optional.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. It should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of reporting conflicting use of a node identifier, comprising:
receiving signals via a wireless link;
identifying, based on the received signals, a conflicting use of a node identifier by a plurality of nodes; and
reporting the conflicting use to at least one network node.

2. The method of claim 1, wherein the conflicting use is reported after delaying for a period of time after the identification.

3. The method of claim 2, wherein the period of time is a random period time.

4. The method of claim 2, wherein the period of time corresponds to as soon as the conflicting use is able to be reported by an access terminal that identified the conflicting use.

5. The method of claim 2, wherein the period of time corresponds to a next time a connection is made, by an access terminal that identified the conflicting use, for a purpose other than reporting the use.

6. The method of claim 2, wherein a duration of the period of time is based on whether an access terminal that identified the conflicting use is idle or connected.

7. The method of claim 1, wherein the at least one network node is one of the plurality of nodes with the identified conflicting use of the node identifier.

8. The method of claim 1, wherein the at least one network node is not one of the plurality of nodes with the identified conflicting use of the node identifier.

9. The method of claim 1, wherein the at least one network node comprises a network operations and management entity.

10. The method of claim 1, wherein the at least one network node comprises a serving access point of an access terminal that identified the conflicting use.

11. The method of claim 1, wherein the identification of the conflicting use comprises identifying a plurality of nodes within a defined proximity that use the node identifier.

12. The method of claim 11, wherein:
the identification of the conflicting use comprises identifying a plurality of neighboring nodes that use the node identifier; and
the neighboring nodes comprise one-hop neighbors or two-hop neighbors.

13. The method of claim 1, wherein the identification of the conflicting use comprises identifying a plurality of nodes that use the node identifier within a defined period of time.

14. The method of claim 1, wherein the conflicting use is identified by an access terminal.

15. The method of claim 1, wherein the conflicting use is identified by an access point.

16. The method of claim 15, wherein the access point is one of the nodes.

17. The method of claim 1, wherein the conflicting use comprises physical cell identifier collision.

18. The method of claim 1, wherein the conflicting use comprises physical cell identifier confusion.

19. An apparatus for reporting conflicting use of a node identifier, comprising:
a receiver configured to receive signals via a wireless link; and
a conflict identifier configured to identify, based on the received signals, a conflicting use of a node identifier by a plurality of nodes, and further configured to report the conflicting use to at least one network node.

20. The apparatus of claim 19, wherein the conflicting use is reported after delaying for a period of time after the identification.

21. The apparatus of claim 20, wherein the period of time is a random period time.

22. The apparatus of claim 20, wherein a duration of the period of time is based on whether an access terminal that identified the conflicting use is idle or connected.

23. The apparatus of claim 19, wherein the conflicting use comprises physical cell identifier collision or physical cell identifier confusion.

24. An apparatus for reporting conflicting use of a node identifier, comprising:
means for receiving signals via a wireless link;
means for identifying, based on the received signals, a conflicting use of a node identifier by a plurality of nodes; and
means for reporting the conflicting use to at least one network node.

25. The apparatus of claim 24, wherein the conflicting use is reported after delaying for a period of time after the identification.

26. The apparatus of claim 25, wherein the period of time is a random period time.

27. A computer-program product, comprising:
computer-readable medium comprising code for causing a computer to:
receive signals via a wireless link;
identify, based on the received signals, a conflicting use of a node identifier by a plurality of nodes; and
report the conflicting use to at least one network node.

28. The computer-program product of claim 27, wherein the conflicting use is reported after delaying for a period of time after the identification.

29. The computer-program product of claim 28, wherein the period of time is a random period time.

30. A method of identifying conflicting use of a node identifier, comprising:
using a node identifier having a first value at a first access point;
receiving a signal that indicates that a second access point also uses the first value of the node identifier; and
determining that the uses of the node identifier by the first and second access points are conflicting.

31. The method of claim 30, wherein the received signal comprises a message from an access terminal served by the first access point.

32. The method of claim 30, wherein the received signal comprises a message from the second access point.

33. The method of claim 32, wherein the message is received via a network backhaul.

34. The method of claim 32, wherein the message is received via a wireless link.

35. The method of claim 30, wherein the received signal comprises a message from a third access point.

36. The method of claim 30, wherein the received signal comprises a message from a network operations and management entity.

37. The method of claim 30, wherein the determination comprises determining whether the second access point is within a defined proximity to the first access point.

38. The method of claim 30, wherein:
the determination comprises determining that the second access point is a neighboring node of the first access point; and
a neighboring node comprises a one-hop neighbor or a two-hop neighbor.

39. The method of claim 30, wherein the determination comprises determining whether the first and second access points use the node identifier within a defined period of time.

40. The method of claim 30, further comprising electing to use a different node identifier based on the determination.

41. The method of claim 30, further comprising reporting the conflicting uses to at least one network node based on the determination.

42. The method of claim 30, wherein the received signal identifies the second access point.

43. The method of claim 42, further comprising sending a message to the second access point to inform the second access point of the conflicting uses.

44. The method of claim 30, wherein the conflicting uses comprise physical cell identifier collision.

45. The method of claim 30, wherein the conflicting uses comprise physical cell identifier confusion.

46. An apparatus for identifying conflicting use of a node identifier, comprising:
an identifier controller configured to use a node identifier having a first value at a first access point; and
a conflict identifier configured to receive a signal that indicates that a second access point also uses the first value of the node identifier, and further configured to determine that the uses of the node identifier by the first and second access points are conflicting.

47. The apparatus of claim 46, wherein the identifier controller is further configured to elect to use a different node identifier based on the determination.

48. The apparatus of claim 46, wherein the conflict identifier is further configured to report the conflicting uses to at least one network node based on the determination.

49. The apparatus of claim 46, wherein the received signal comprises a message from an access terminal served by the first access point.

50. The apparatus of claim 46, wherein the conflicting uses comprise physical cell identifier collision or physical cell identifier confusion.

51. An apparatus for identifying conflicting use of a node identifier, comprising:
means for using a node identifier having a first value at a first access point;
means for receiving a signal that indicates that a second access point also uses the first value of the node identifier; and
means for determining that the uses of the node identifier by the first and second access points are conflicting.

52. The apparatus of claim 51, further comprising means for electing to use a different node identifier based on the determination.

53. The apparatus of claim 51, further comprising means for reporting the conflicting uses to at least one network node based on the determination.

54. A computer-program product, comprising:
computer-readable medium comprising code for causing a computer to:
use a node identifier having a first value at a first access point;
receive a signal that indicates that a second access point also uses the first value of the node identifier; and
determine that the uses of the node identifier by the first and second access points are conflicting.

55. The computer-program product of claim 54, wherein the computer-readable medium further comprises code for causing the computer to elect to use a different node identifier based on the determination.

56. The computer-program product of claim 54, wherein the computer-readable medium further comprises code for causing the computer to report the conflicting uses to at least one network node based on the determination.

57. A method of resolving conflicting use of a node identifier, comprising:
identifying conflicting use of a node identifier by a plurality of nodes; and
negotiating with at least one of the nodes to cause one or more of the nodes to use a different node identifier.

58. The method of claim 57, wherein the negotiation comprises:
sending an indication of a proposed use of the different node identifier to one of the nodes;
receiving a response to the indication; and
determining whether to use the different node identifier based on the response.

59. The method of claim 58, wherein the identification comprises:
sending a first message to a neighboring node to inquire into use of the node identifier by the neighboring node;
receiving, in response to the first message, a second message that indicates that the node identifier is used by the neighboring node, wherein the indication is sent as a result of the response.

60. The method of claim 57, wherein:
the identification comprises receiving an indication of a proposed use of the different node identifier from one of the nodes;
the identification further comprises determining whether use of the different node identifier by the one of the nodes conflicts with use of the different node identifier by any of the plurality of nodes or some other node; and
the negotiation comprises sending a response to the one of the nodes based on the determination.

61. The method of claim 57, wherein the identification comprises receiving an indication of the conflicting use from an access terminal.

62. The method of claim 57, wherein the conflicting use comprises physical cell identifier collision.

63. The method of claim 57, wherein the conflicting use comprises physical cell identifier confusion.

64. An apparatus for resolving conflicting use of a node identifier, comprising:
a conflict identifier configured to identify conflicting use of a node identifier by a plurality of nodes; and
an identifier controller configured to negotiate with at least one of the nodes to cause one or more of the nodes to use a different node identifier.

65. The apparatus of claim 64, wherein the negotiation comprises:
sending an indication of a proposed use of the different node identifier to one of the nodes;
receiving a response to the indication; and
determining whether to use the different node identifier based on the response.

66. The apparatus of claim 64, wherein:
the identification comprises receiving an indication of a proposed use of the different node identifier from one of the nodes;
the identification further comprises determining whether use of the different node identifier by the one of the nodes conflicts with use of the different node identifier by any of the plurality of nodes or some other node; and
the negotiation comprises sending a response to the one of the nodes based on the determination.

67. The apparatus of claim 64, wherein the conflicting use comprises physical cell identifier collision or physical cell identifier confusion.

68. An apparatus for resolving conflicting use of a node identifier, comprising:
means for identifying conflicting use of a node identifier by a plurality of nodes; and
means for negotiating with at least one of the nodes to cause one or more of the nodes to use a different node identifier.

69. The apparatus of claim 68, wherein the negotiation comprises:
sending an indication of a proposed use of the different node identifier to one of the nodes;
receiving a response to the indication; and
determining whether to use the different node identifier based on the response.

70. A computer-program product, comprising:
computer-readable medium comprising code for causing a computer to:
identify conflicting use of a node identifier by a plurality of nodes; and
negotiate with at least one of the nodes to cause one or more of the nodes to use a different node identifier.

71. The computer-program product of claim 70, wherein the negotiation comprises:
sending an indication of a proposed use of the different node identifier to one of the nodes;
receiving a response to the indication; and
determining whether to use the different node identifier based on the response.

72. A method of resolving conflicting use of a node identifier, comprising:
identifying conflicting use of a node identifier by a plurality of nodes;
delaying for a period of time after the identification; and
determining, after the delaying, whether to use a different node identifier at one of the nodes.

73. The method of claim 72, wherein the determination comprises electing to use the different node identifier at the one of the nodes immediately after the delaying.

74. The method of claim 72, further comprising monitoring for information relating to the conflicting use after the identifying, wherein the determination is based on the monitoring.

75. The method of claim 72, wherein the determination is based on whether an indication of the conflicting use is received at the one of the nodes after the delaying.

76. The method of claim 75, wherein the indication is received via at least one of the group consisting of: an access point, one of the plurality of nodes, a network operations and management entity, a wireless link, and a network backhaul.

77. The method of claim 72, wherein the period of time comprises a random period of time.

78. The method of claim 72, wherein a duration of the period of time is based on a node type of at least one of the nodes.

79. The method of claim 72, wherein a duration of the period of time is based on how long at least one of the nodes has been using the node identifier.

80. The method of claim 72, wherein a duration of the period of time is based on a quantity of node identifiers available for use by at least one of the nodes.

81. The method of claim 72, wherein a duration of the period of time is based on a quantity of access terminals associated with at least one of the nodes.

82. The method of claim 72, wherein the conflicting use comprises physical cell identifier collision.

83. The method of claim 72, wherein the period of time is randomly selected from a set of delay values that is weighted based on at least one characteristic associated with the one of the nodes.

84. The method of claim 72, wherein the conflicting use comprises physical cell identifier confusion.

85. An apparatus for resolving conflicting use of a node identifier, comprising:
a conflict identifier configured to identify conflicting use of a node identifier by a plurality of nodes; and
an identifier controller configured to delay for a period of time after the identification, and further configure to determine, after the delaying, whether to use a different node identifier at one of the nodes.

86. The apparatus of claim 85, wherein:
the identifier controller is further configured to monitor for information relating to the conflicting use after the identifying; and
the determination is based on the monitoring.

87. The apparatus of claim 85, wherein the period of time comprises a random period of time.

88. The apparatus of claim 85, wherein a duration of the period of time is based on a node type of at least one of the nodes.

89. The apparatus of claim 85, wherein a duration of the period of time is based on how long at least one of the nodes has been using the node identifier.

90. The apparatus of claim 85, wherein a duration of the period of time is based on a quantity of node identifiers available for use by at least one of the nodes.

91. The apparatus of claim 85, wherein a duration of the period of time is based on a quantity of access terminals associated with at least one of the nodes.

92. The apparatus of claim 85, wherein the conflicting use comprises physical cell identifier collision or physical cell identifier confusion.

93. An apparatus for resolving conflicting use of a node identifier, comprising:
means for identifying conflicting use of a node identifier by a plurality of nodes;
means for delaying for a period of time after the identification; and
means for determining, after the delaying, whether to use a different node identifier at one of the nodes.

94. The apparatus of claim 93, further comprising means for monitoring for information relating to the conflicting use after the identifying, wherein the determination is based on the monitoring.

95. The apparatus of claim 93, wherein the period of time comprises a random period of time.

96. The apparatus of claim 93, wherein a duration of the period of time is based on a node type of at least one of the nodes.

97. A computer-program product, comprising:
computer-readable medium comprising code for causing a computer to:
identify conflicting use of a node identifier by a plurality of nodes;
delay for a period of time after the identification; and
determine, after the delaying, whether to use a different node identifier at one of the nodes.

98. The computer-program product of claim 97, wherein:
the computer-readable medium further comprises code for causing the computer to monitor for information relating to the conflicting use after the identifying; and
the determination is based on the monitoring.

99. The computer-program product of claim 97, wherein the period of time comprises a random period of time.

100. The computer-program product of claim 97, wherein a duration of the period of time is based on a node type of at least one of the nodes.
